(19) United States
(12) Patent Application Publication
(10) Pub. No.: US 2013/0154951 A1
(43) Pub. Date: Jun. 20, 2013

(54) Performing a Function

(71) Applicants: Mathew LAIBOWITZ, Los Angeles, CA (US); Vidyut Samanta, Los Angeles, CA (US); Joseph A. Paradiso, (US)

(72) Inventors: Mathew LAIBOWITZ, Los Angeles, CA (US); Vidyut Samanta, Los Angeles, CA (US); Joseph A. Paradiso, (US)

(73) Assignee: NOKIA CORPORATION, Espoo (FI)

(21) Appl. No.: 13/327,729

(22) Filed: Dec. 15, 2011

(51) Int. Cl. G06F 3/041

(52) U.S. Cl. 345/173

(57) ABSTRACT

A method, apparatus, and computer product for: receiving a first user input indicative of a movement of a device; receiving a second user input indicative of a touch gesture entered on the device; determining that a combination of the first and second user inputs is associated with a function having at least first and second parameters; determining the first parameter based upon at least the first user input; determining the second parameter based upon at least the second user input; and causing the function to be performed according to the determined first and second parameters.

### TECHNICAL FIELD

The present application relates generally to the performance of a function having parameters that are determined based on at least a touch user input and a movement user input.

### BACKGROUND

Modern computing devices have increasingly sophisticated functionality and are capable of increasing numbers of complex tasks. In order to provide the user with easy access to such tasks and simple ways of configuring them, there has been a great effort to develop new ways of handling user input.

### SUMMARY

According to a first example there is provided a method comprising: receiving a first user input indicative of a movement of a device; receiving a second user input indicative of a touch gesture entered on the device; determining that a combination of the first and second user inputs is associated with a function having at least first and second parameters; determining the first parameter based upon at least the first user input; determining the second parameter based upon at least the second user input; and causing the function to be performed according to the determined first and second parameters.

According to a second example there is provided apparatus comprising: a processor; and memory including computer program code, the memory and the computer program code configured to, working with the processor, cause the apparatus to perform at least the following: receive a first user input indicative of a movement of a device; receive a second user input indicative of a touch gesture entered on the device; determine that a combination of the first and second user inputs is associated with a function having at least first and second parameters; determine the first parameter based upon at least the first user input; determine the second parameter based upon at least the second user input; and cause the function to be performed according to the determined first and second parameters.

According to a third example there is provided computer program product comprising a computer-readable medium bearing computer program code embodied therein for use with a computer, the computer program code comprising: code for receiving a first user input indicative of a movement of a device; code for receiving a second user input indicative of a touch gesture entered on the device; code for determining that a combination of the first and second user inputs is associated with a function having at least first and second parameters; code for determining the first parameter based upon at least the first user input; code for determining the second parameter based upon at least the second user input; and code for causing the function to be performed according to the determined first and second parameters.

Also disclosed is apparatus comprising means for receiving a first user input indicative of a movement of a device; means for receiving a second user input indicative of a touch gesture entered on the device; means for determining that a combination of the first and second user inputs is associated with a function having at least first and second parameters; means for determining the first parameter based upon at least the first user input; means for determining the second parameter based upon at least the second user input; and means for causing the function to be performed according to the determined first and second parameters.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus according to an example embodiment;

FIG. 2 is an illustration of an alternative apparatus according to an example embodiment;

FIG. 3 is an illustration of a further example of the apparatus of FIG. 1;

FIGS. 4A-C are illustrations of an apparatus according to an example embodiment;

FIGS. 5A-D are illustrations of an apparatus according to an example embodiment;

FIGS. 6A-E are illustrations of an apparatus according to an example embodiment; and

FIG. 7 is a flow chart illustrating a method according to an example embodiment.

### DETAILED DESCRIPTION OF THE DRAWINGS

Example embodiments of the present invention and their potential advantages may be understood by reference to the drawings.

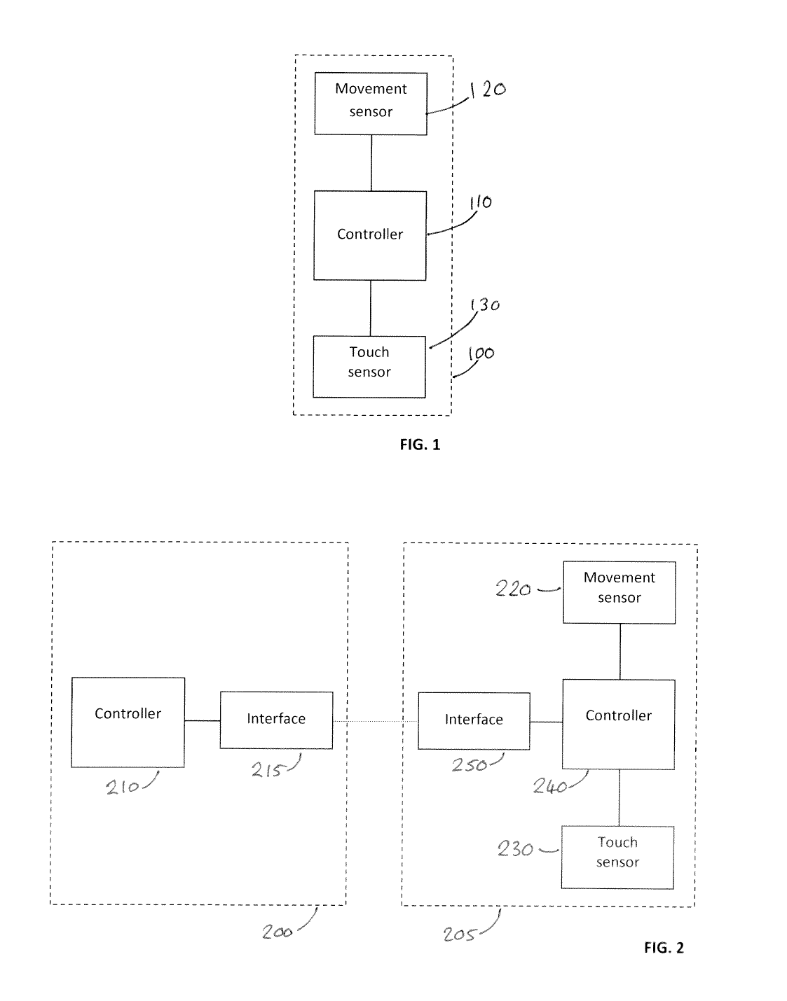

FIG. 1 illustrates an apparatus 100 according to an example embodiment of the invention. The apparatus comprises a controller 110 that is connected (functionally and/or physically) to a movement sensor 120 and a touch sensor 130. The movement sensor 120 and touch sensor 130 are both capable of providing user input to the controller 100.

The movement sensor 120 is capable of providing a user input to the controller 110 that is indicative of a movement of the apparatus 100. Suitable sensors may include accelerometers and other inertial motion sensors, magnetometers and other field-sensing movement sensors, and/or any other suitable movement sensing technology. The movement sensor 120 may be an optical or other sensor that detects movement of the apparatus relative to one or more external reference points or fields that the movement senor 120 can detect (either independently or in cooperation with the controller 100 or other logic). The movement sensor 120 may comprise a receiver for receiving an indication of the apparatus's 100 movement from an external source (e.g. an external camera or other detector that monitors the position and/or orientation of the apparatus 100 and provide information regarding such movement to the movement sensor 120). Thus the movement sensor 120 may not necessarily itself detect movement of the apparatus 100, and in some embodiments the movement sensor 120 will act to interpret information regarding such movement from another source and to provide a user input to the controller 110 that is indicative of the movement detected elsewhere.

When reference is made herein to the sensing of the “movement” of an object (such as apparatus 100) or a user input that is indicative of such a movement, the use of the term “movement” does not necessarily mean that there must be a change in the position and/or orientation of the object. Instead, it is also meaningful to talk about sensing the “movement” of an entirely stationary object since this effectively a null movement. What is more, a determination that an object is stationary is necessarily based upon an observation of its movement and the determination that the movement is null. However, it is also to be understood that any of the embodiments described herein may be modified to require that the movement user input is indicative of a non-null movement (i.e. a movement in which there is a sensed change sensed in at least one of position and orientation).

The touch sensor 130 is capable of providing a user input to the controller 110 that is indicative of a touch gesture that is entered on the apparatus. Suitable sensors may include capacitive, resistive, or other touchpad or touchscreen technologies, cameras and other optical sensors for recognising touch gestures performed on the apparatus 100, and/or any other suitable sensor technology. The touch sensor 130 may comprise a receiver for receiving an indication of a touch gesture made on the apparatus 100 from an external source (e.g. an external camera or other detector that is able to recognise a touch gesture performed on the apparatus 100 and provide information regarding such a touch gesture to the touch sensor 130). Thus the touch sensor 130 itself may not necessarily detect a touch gesture performed on the apparatus 100 and in some embodiments the touch sensor 130 acts to interpret information regarding such a touch gesture from another source and to provide a user input to the controller 110 that is indicative of the touch gesture.

Where the touch gesture is performed “on” an apparatus, this may comprise a touch gesture that is directly detected by a touch sensor that is comprised by the apparatus, or it may refer to a touch gesture that is detected elsewhere but performed at a location that is defined relative to a point or surface comprised by the apparatus. For example, a touch gesture may be traced on a surface of an apparatus but detected by a device that does not form part of the apparatus—the touch gesture would still be said to have been performed “on” the apparatus.

A “touch” input may comprise any input that is detected by a touch sensor including touch events that involve actual physical contact and touch events that do not involve physical contact but that are otherwise detected, such as a result of the proximity of the selection object to the touch sensor (e.g. a “hover”).

The controller 110 is capable of receiving user inputs from the movement sensor 120 and the touch sensor 130, and of determining whether or not a combination of the first and second user inputs is associated with a function that has at least first and second parameters. If the combination is associated with such a function, the controller 110 is capable of determining the first parameter based upon at least the user input received from the movement sensor 120 and determining the second parameter based upon at least the user input received from the touch sensor 130, and of causing the function to be performed according to these determined parameters. The controller may comprise any suitable technology. For example, it may comprise a general purpose processor that is configured to perform suitable instructions that are stored a one or more memories that are internal or external to the processor. The controller may comprise a Field Programmable Gate Array, an application-specific integrated circuit, hardwired logic gates, and/or logic provided according to any other suitable arrangement.

The first parameter may be based on one or more of a number of characteristics of the movement indicated by the movement user input. For example, it may be based on a direction, acceleration, speed, or duration of the movement, or upon any combination of these. Any of these characteristics may be an instantaneous value or a value that has been determined based on an average or other combination of multiple values.

Similarly, the second parameter may be based on one or more of a number of characteristics of the touch gesture indicated by the touch user input. For example, it may be based on a location, shape, direction, acceleration, speed, motion, or duration of the gesture, or upon any combination of these. Any of these characteristics may be an instantaneous value or a value that has been determined based on an average or other combination of multiple values.

FIG. 2 shows an alternative apparatus 200 according to another example embodiment of the invention. Apparatus 200 comprises a controller 210 similar to that 110 of FIG. 1. However, apparatus 200 does not itself comprise a movement or touch sensor. Instead, apparatus 200 comprises an interface 215 through which it is connected to a separate device 205 that comprises a movement sensor 220 and touch sensor 230. The movement sensor 220 and touch sensor 230 of device 205 are similar to those 120, 130 shown in FIG. 1. Separate device 205 also comprises an interface 205 through which it is linked to the apparatus 200 and a controller 240 comprising a microprocessor and memory, or any other suitable logic, capable of providing user inputs from the movement sensor 220 and touch sensor 240 to apparatus 200 via interface 250. These user inputs can then be received by the controller 210 of apparatus 200, which can associate their combination with a function, determine the parameters of that function, and cause the function to be performed as described above in relation to FIG. 1.

The separate device 205 of FIG. 2 need not comprise a separate controller 240 in the event that the touch sensor 220 and movement sensor 230 can communicate the user inputs directly to apparatus 200. Each of interfaces 215 and 250 may be active in the sense that they perform encoding and/or decoding or other processing of communications between the devices, or may be passive in that they provide only a channel for communications (e.g. in some embodiments the interface may comprise or consist of one or more wires or other connectors).

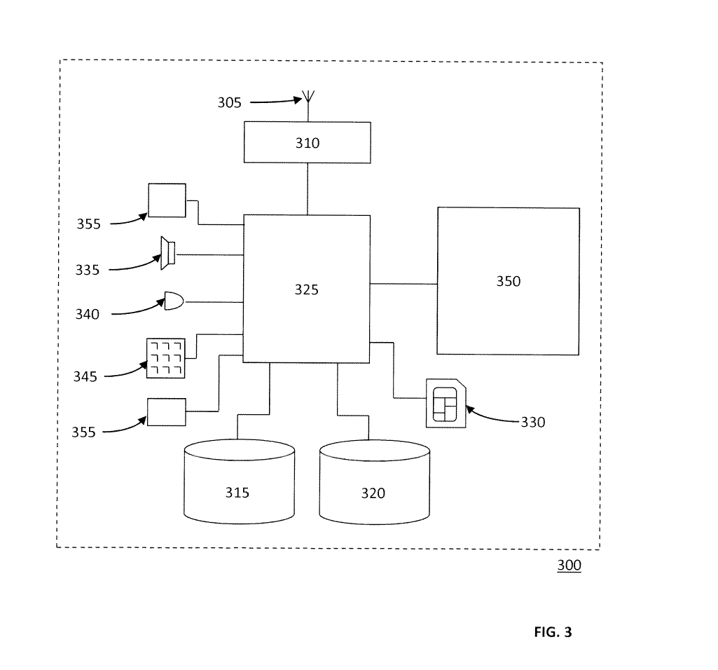

FIG. 3 illustrates an example of a device 300 in which the apparatus 100 of FIG. 1 may be embodied. In this example, the device 300 is a mobile telephony device such as a mobile phone. However, the invention may be embodied in different apparatus—for example a personal computer, a media player device such as a portable music player, an internet or other tablet device, a personal digital assistant, a games console or a controller therefore, a computer peripheral, or any other suitable apparatus.

Device 300 may comprise at least one antenna 305 that may be communicatively coupled to a transmitter and/or receiver component 310. The device 300 may also comprise a volatile memory 115, such as volatile Random Access Memory (RAM) that may include a cache area for the temporary storage of data. The device 300 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the device 300, such as the functions described hereinafter. In some example embodiments, the processor 125 and at least one of volatile 115 or non-volatile 120 memories may be present in the form of an Application Specific Integrated Circuit (ASIC), a Field Programmable Gate Array (FPGA), or any other application-specific component. Although the term “processor” is used in the singular, it may refer either to a single processor (e.g. an FPGA or a single CPU), or an arrangement of more than one single processors that cooperate to provide an overall processing function (e.g. two or more FPGAs or CPUs that operate in a parallel processing arrangement).

The device 300 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The device 300 may comprise a number of user interface components. For example, a microphone 135 and an audio output device such as a speaker 140. The device 300 may comprise one or more hardware controls, for example a plurality of keys laid out in a keypad 145. In addition, or alternatively, the device 300 may comprise one or more interface devices such as a joystick, trackball, or other suitable device.

The device 300 illustrated in FIG. 3 comprises a touch sensor 355. The touch sensor may comprise (or be comprised by) a touch screen. The touch sensor may alternatively comprise a touch pad or any other suitable touch sensitive device. The touch sensor may use any suitable technology to detect touch gestures made with, for example, a user's finger or other stylus. Suitable technologies may include sensors that detect touch gestures based on resistance, capacitance, infrared detection, strain measurement, surface waves, optical imaging, dispersive signal technology, acoustic pulse recognition or other techniques.

The device 300 may comprise one or more display devices such as a screen 150. The screen 150 may be a touchscreen, in which case it may be configured to receive input from a single point of contact, multiple points of contact, and/or the like. In such an example embodiment, the touchscreen may determine input based on position, motion, speed, contact area, and/or the like. Suitable touchscreens may involve those that employ resistive, capacitive, infrared, strain gauge, surface wave, optical imaging, dispersive signal technology, acoustic pulse recognition or other techniques, and to then provide signals indicative of the location and other parameters associated with the touch. If display 150 is a touchscreen then it may provide touch sensing functionality in place of the separate touch sensor 355.

In other examples, displays of other types may be used. For example, a projector may be used to project a display onto a surface such as a wall. In some further examples, the user may interact with the projected display, for example by touching projected user interface elements. Various technologies exist for implementing such an arrangement, for example by analysing video of the user interacting with the display in order to identify touches and related user inputs.

Examples of the invention will now be described in relation to an apparatus that comprises a touch screen that serves as the touch sensor, and which also comprises a movement sensor. However, it is not intended that this disclosure should necessarily be limited to such embodiments and it has already been explained above that touch sensors other than touch screens, and/or apparatuses that use external touch and movement sensors may be used instead.

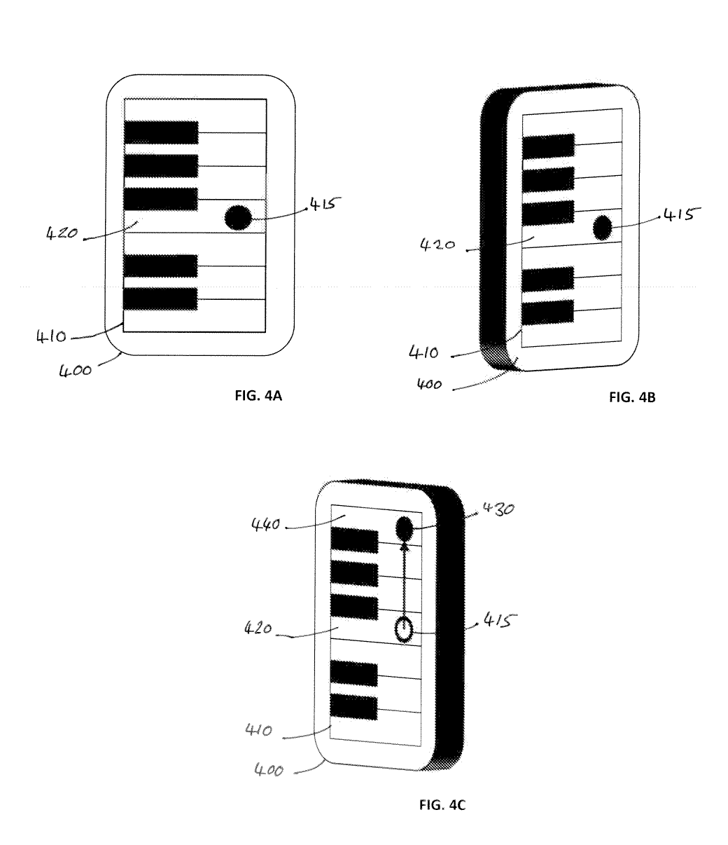

FIGS. 4A-C illustrates an example of an apparatus 400 according to an embodiment of the present invention. The apparatus 400 comprises a touchscreen 410 that serves as the touch sensor. The apparatus 400 also comprises a movement sensor that is capable of detecting movement of the apparatus 400, although this movement sensor is not visible in these figures.

In FIG. 4A one octave of a piano keyboard is displayed on the touchscreen 410 and the user is touching the F key 420 at location 415. The apparatus 400 is held stationary by the user. Thus FIG. 4A illustrates a state in which the touch screen 400 provides a user input that indicates that the user is performing a touch gesture at location 415, an in this case the touch gesture is a stationary touch. The movement sensor provides a user input that indicates that the device is currently stationary.

Apparatus 400 is controlled in such a way that certain combinations of touch and movement user inputs are associated with a function to output a sound. The device may output this sound through an internal speaker, or it may cause the sound to be output otherwise (e.g. by instructing a remote device to output the sound). The function of outputting the sound is a function that is performed according to two or more parameters. In the example illustrated in FIGS. 4A-4C these parameters include a basic pitch parameter and a pitch modifier parameter. The basic pitch parameter corresponds to a note (e.g. a MIDI note number or frequency in Hertz), whereas the pitch modifier represents an increase or decrease in the pitch of the basic pitch that to a variable degree sharpens or flattens the note. The pitch modifier may be, for example, a multiplier that is applied to the basic pitch to determine the pitch of the sound that will be output by the function. For the purposes of this example, the basic pitch is a frequency in Hertz and the pitch modifier is a multiplier.

In this example, the function is associated with the user inputs in such a way that any user input combination in which the current location 415 of the touch gesture overlays one of the displayed piano keys is associated with the function to play a sound at the basic pitch multiplied by the pitch modifier. The basic pitch is determined based upon only the current location of a touch gesture indicated by the touch user input and the pitch modifier is determined based only on the current direction and speed of a rotation of the device indicated by the movement user input (with the direction of the rotation corresponding to a sharpening of flattening modification, and the speed of rotation indicating the extent of the modification).

In FIG. 4A the touch user input indicates that the current location 415 of the touch gesture currently overlays the F key 420 and based upon this the basic pitch parameter is determined to be 349 Hz. The movement user input indicates that the phone is not currently being rotated, and the pitch modifier parameter is therefore determined to be 1. The function of playing a sound is caused to be performed with the basic pitch parameter of 349 Hz and the pitch modifier parameter of 1, resulting in an audio output at 349×1=349 Hz.

Then, whilst the touch gesture remains stationary at location 415, the apparatus is rotated about an axis (an anticlockwise rotation around the vertical axis relative to FIG. 4B, though any suitable axis may be used). The new combination of touch and movement inputs is again one in which the current location 415 of the touch gesture overlays one of the keys (still the F key 420), and this combination is therefore again one that corresponds to the function to output a sound. The basic pitch remains 349 Hz (there is no change to the location 415 of the touch gesture) but in this case the direction and speed of the rotation indicated by the movement user input are determined to result in a pitch modifier parameter of 1.02. The function of causing a sound is therefore caused to be performed with the basic pitch parameter of 349 Hz and the pitch modifier parameter of 1.02, resulting in an audio output at 349×1.02=355 Hz. The rotation of the apparatus 400 shown in FIG. 4B has therefore had the effect of increasing the pitch of the outputted sound.

In FIG. 4C the user has both changed the touch gesture and rotated the phone in the opposite direction around an axis (again the vertical axis—this time in a clockwise direction). The combination of touch and movement user inputs that indicate these sensed conditions is again associated with the function to output a sound (since the new location 430 of the touch gesture again overlays a key on the piano keyboard).

For the case of FIG. 4C a new basic pitch parameter is determined based on the new location 430 of the touch gesture that is indicated by the touch user input. This location corresponds to the B key, and a basic pitch parameter of 494 Hz is determined based upon this. The direction and speed of the movement of the apparatus 400 indicated by the movement user input results in a pitch modification parameter of 0.97. The function of causing a sound is therefore caused to be performed with the basic pitch parameter of 494 Hz and the pitch modifier parameter of 0.97, resulting in an audio output at 494×0.97=479 Hz. The rotation of the apparatus 400 and change in the touch gesture shown in FIG. 4C have therefore had the effect of greatly increasing the pitch of the outputted sound.

It will be understood that changes to the function, the function's parameters, and the criteria that cause a particular combination of user inputs to be associated with that function may each be varied to result in different examples. Similarly, it is not necessarily the case that the touchscreen 410 will display a piano keyboard.

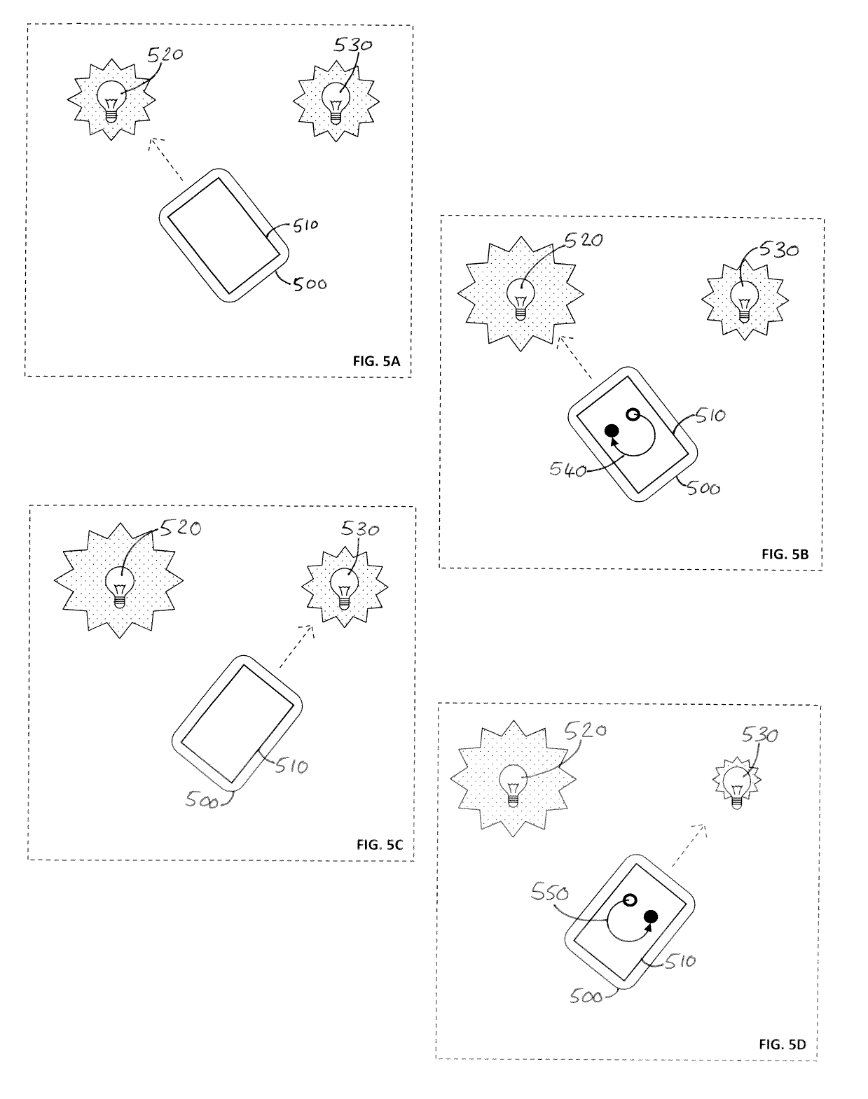

FIGS. 5A-D illustrate a different example of an embodiment of the invention. Again an apparatus 500 with a touchscreen 510 is illustrated, and this apparatus 500 may be equivalent to that 400 described in relation to FIGS. 4A-C, except not necessarily configured to display a piano keyboard or to associate user inputs with an audio output function.

In FIG. 5A the apparatus 500 is illustrated along with two lights 520, 530 located at different positions (one 520 on the left, the other 530 on the right). The lights may be ceiling lights located on opposite sides of a room, for example.

Apparatus 500 is configured to associate certain combinations of movement and touch user inputs with a function that varies the brightness of one or other of the two lights 520, 530. A combination of inputs is associated with this function only if the apparatus 500 is pointing substantially towards one or other of the lights (e.g. to point in a direction within 10° of either light) whilst a touch gesture having an arcuate shape is traced on the touchscreen 410.

The function takes two parameters. The first parameter indicates which of the two lights is to be adjusted, and is based on the movement of the apparatus 500. The function adjusts the left hand light 520 if the device is pointing closer to that light 520 than the right hand light 530, and adjusts the right hand light 530 otherwise. The second parameter indicates whether the light 520, 530 identified by the first parameter is to be brightened or dimmed, and to what extent; with the function brightening the light 520, 530 if the gesture is a clockwise arc and dimming the identified light if the gesture is an anticlockwise arc, and adjusting the brightness of the identified light in proportion to the angle through which the arcuate touch gesture is been traced.

In FIG. 5A the apparatus 500 is pointed directly towards the left hand light 520 but no touch gesture is being made. The combination of the movement and touch inputs therefore do not satisfy both of the conditions that the apparatus 500 is pointed substantially towards a light 520 530 and that an arcuate touch gesture is being traced on the touchscreen 510. Therefore, in this case the combination of the touch inputs is not associated with the function to adjust the lights' brightness.

In FIG. 5B the apparatus 500 remains pointed directly towards the left hand light 520 and the user is part way through tracing a clockwise arcuate gesture 540 on the touchscreen 510, the arc at the illustrated moment in time being 270°. The resulting combination of touch and movement inputs is therefore associated with the brightness-adjusting function. In this example, the first parameter is determined as requiring the left hand light 520 to be adjusted because the apparatus 500 is pointed more closely towards that light. The second parameter is determined to be a brightening adjustment because the arcuate gesture is clockwise, and the extent of this brightening is calculated based on the 270° angle of the arc. FIG. 5B illustrates the result of the performance of the function according to these parameters, the left hand light 520 having increased in brightness.

In FIG. 5C the apparatus 500 has been rotated to point directly at the right hand light 530; however, no touch gesture is being made. The combination of the movement and touch inputs therefore do not satisfy both of the conditions that the apparatus 500 is pointed substantially towards a light 520 530 and that an arcuate touch gesture is being traced on the touchscreen 510. Therefore, in this case the combination of the touch inputs is not associated with the function to adjust the lights' brightness.

In FIG. 5D the apparatus 500 remains pointed directly towards the right hand light 530 and the user is part way through tracing an anticlockwise arcuate gesture 550 on the touchscreen 510, the arc at the illustrated moment in time being 270°. The resulting combination of touch and movement inputs is therefore associated with the brightness-adjusting function. In this example, the first parameter is determined as requiring the right hand light 530 to be adjusted because the apparatus 500 is pointed more closely towards that light. The second parameter is determined to be a dimming adjustment because the arcuate gesture is anticlockwise, and the extent of this brightening is calculated based on the 270° angle of the arc. FIG. 5B illustrates the result of the performance of the function according to these parameters, the right hand light 530 having decreased in brightness.

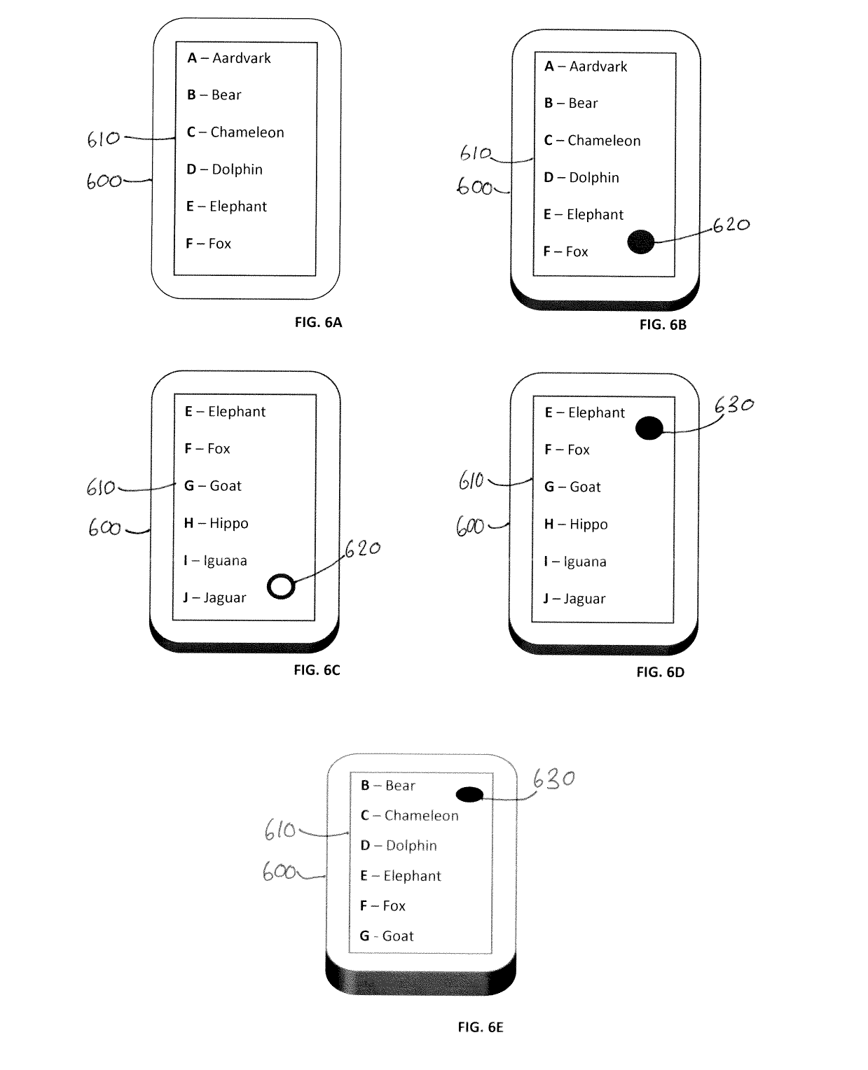

FIGS. 6A-E illustrate a different example of an embodiment of the invention. Again an apparatus 600 with a touchscreen 610 is illustrated, and this apparatus 600 may again be equivalent to that 400 described in relation to FIGS. 4A-C, except not necessarily configured to display a piano keyboard or to associate user inputs with an audio output function.

In FIG. 6A the touchscreen is displaying a portion of a list of animal names. The portion of the list that is displayed consists of those animals with names from A to F, but the full list is in fact much longer. The list is a scrollable list and the apparatus 600 is configured to perform a scrolling function that allows the displayed portion of the list to be displayed. For example, if the list shown in FIG. 6A were to be scrolled downwards then animals with names from G onwards would be scrolled onto the bottom of the list whilst animals at the top of the list (e.g. “Aardvark”) are scrolled off the top of the list.

The scrolling function is only activated when particular combinations of movement and touch inputs are received. In this example, the touch input must be indicative of a touch gesture somewhere (anywhere) on the touchscreen, and the movement input must indicate that the apparatus 600 has been tilted by more than a threshold amount (e.g. 5°) from a reference position.

The scrolling function has two parameters. The first parameter is the direction in which the scrolling is to take place (up or down the list), and the second parameter is the magnitude of the scroll. The first parameter is determined based on the current location of the touch gesture: if the touch gesture is currently in the upper half of the screen then the list is scrolled up, and if the touch gesture is currently in the lower half of the screen then the list is scrolled down. The second parameter is based on the angle through which the device has been tilted from the reference position. An example of a scale that may be used to map the tilt angle to the extent of the scroll is a linear increase in scrolling distance from the threshold angle (in this example 5°) to a tilt of 90° from the reference position. A tilt of the threshold angle may correspond to a scroll of zero distance, and a tilt of 90° to a scroll of the full extent of the list.

The tilting movement may be relative to an absolute reference position (e.g. a tilt relative to a vertical orientation defined by gravity) or it may be relative to a previous position of the apparatus 600. In this example, the tilting is relative to the orientation of the apparatus 600 immediately prior to the start of the most recent touch gesture.

In FIG. 6B the user has commenced a touch gesture at location 620 on the touchscreen 610. Since touching the screen to commence this touch gesture, the user has also tilted the apparatus 600 backwards through more than 5°. Such a combination of user inputs is one which is associated with the scrolling function.

In the example shown in FIG. 6B the current location 620 of the touch gesture indicated by the touch user input lies in the lower half of the touchscreen 610 and first parameter of the scrolling function is therefore determined to represent a downwards direction of scroll. The angle through which the apparatus has been tilted from its position when the most recent touch gesture was commenced is indicated to be 15° by the movement user input gesture, and this is scaled to determine a second parameter of the scrolling function that represents a scroll distance of 6 list items. The scrolling function therefore has the effect of scrolling the list downward by 6 list items, as shown on the illustration of the touch screen 610 in FIG. 6B.

The apparatus 600 is now held stationary, but the user's finger is lifted from the touchscreen 610 as shown in FIG. 6C. In FIG. 6B the user has commenced a touch gesture at location 620 on the touchscreen 610. Although the apparatus 600 remains tilted by more than 5° from its position when the most recent touch gesture was commenced, there is currently no touch gesture located anywhere on the touchscreen 610. Therefore, the new combination of user inputs is not one which is associated with the scrolling function, and no further scrolling of the list is performed.

In FIG. 6D the user has commenced a new touch gesture at location 630, which is in the upper half of the touchscreen 610. However, the apparatus 600 has not been tilted by more than 5° since this gesture was commenced (it remains in the orientation shown in FIG. 6C). Therefore, the new combination of user inputs is still not one which is associated with the scrolling function, and no further scrolling of the list is performed.

The user now leaves his finger at location 630 on the touchscreen 610, but tilts the device further back by 13°, as illustrated in FIG. 6E. The resulting combination of user inputs indicate both that there is a touch gesture being performed at a location on the touchscreen 610 and that the device has been tilted through more than the threshold 5° since the most recent touch gesture was commenced. As a result, the combination of user inputs is one which is associated with the scrolling function.

Since the touch user input is indicative of a touch gesture that is currently in the upper half of the touchscreen 610, the first parameter is determined to represent an upwards direction of scroll. The angle through which the apparatus has been tilted from its position when the most recent touch gesture was commenced is indicated to be 13° by the movement user input gesture, and this is scaled to determine a second parameter of the scrolling function that represents a scroll distance of 5 list items. The scrolling function therefore has the effect of scrolling the list upward by 5 list items, as shown on the illustration of the touch screen 610 in FIG. 6E.

In the above examples the combination of the movement and touch user inputs has been a simultaneous one. That is, only combinations in which the movement user input and the touch user input each satisfy a particular criterion at exactly the same time are associated with a particular function (although the condition imposed on the inputs may be non-limiting, i.e. it is satisfied in all cases). However, other combinations may be associated with the function in addition or as an alternative.

For example, a requirement that the movement and touch inputs must simultaneously satisfy given criteria to result in a combination that will be associated with a particular function may be relaxed to require that they satisfy the criteria only substantially simultaneously. That is to say, each of the user inputs must satisfy its criterion either simultaneously or within a threshold time of each other. So long as the criteria are met within the threshold time, they can be said to have been met “substantially simultaneously” and the combination may be associated with the function. Example threshold times are 0.1 seconds, 0.5 seconds, and 1 second; however, in different examples any suitable threshold time may be used and the suitability of a given threshold will depend on the use case.

For the avoidance of doubt, “simultaneously” falls within the scope of “substantially simultaneously”.

In some examples the criteria need not be met even substantially simultaneously. For example, the function may be associated with a combination of a movement input and touch input that are indicative of a movement and touch gesture that have occurred at any time in the past, or that occur at times that are defined by a criterion that may include a proximity to one another that is not substantially simultaneous. For example, a function may be associated with a combination of touch and movement user inputs that requires that a particular touch gesture occurs at any time after a given movement, but where it must be the first touch gesture to occur after that movement.

In some example embodiments the function may have only two parameters. However, in others the function may have more than parameter. Where reference is made to a first parameter being determined based on a first one of the touch and movement user inputs and a second parameter being determined based on a second one of the touch and movement user inputs, this does not necessarily preclude the existence of third or more parameter that may be determined based on either of the user inputs, both of the user inputs, or neither of the inputs. Similarly, either or both of the first and second parameters may in different examples, be determined based upon only one of the user inputs, both of the user inputs, or either of the user inputs in combination with any other criterion.

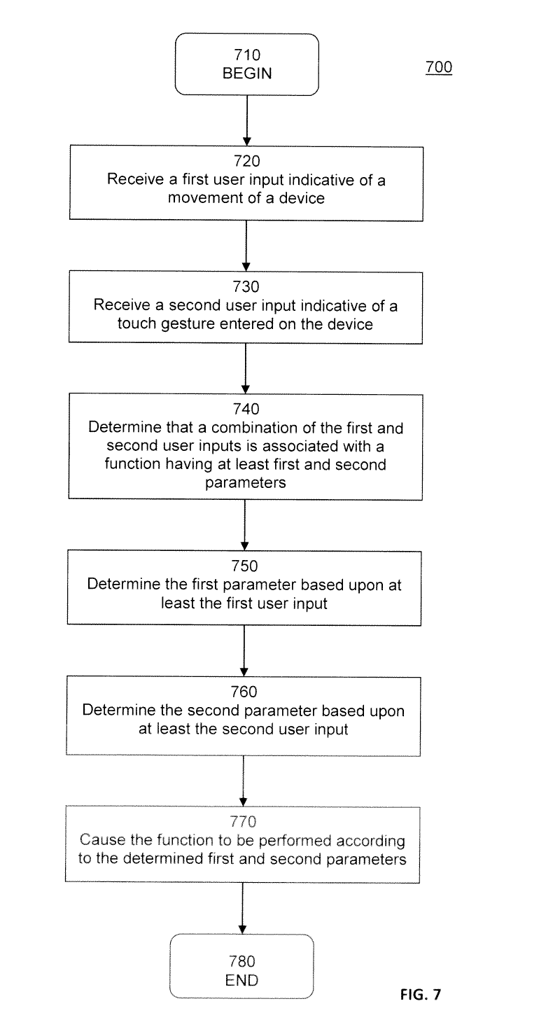

FIG. 7 illustrates a method 700 suitable for implementing examples embodiments of the present invention. On beginning 710, the method 700 involves receiving 720 a first user input indicative of a movement of a device, and receiving 730 a second user input indicative of a touch gesture entered on the device. Then a determination is made 740 as to whether a combination of the first and second user inputs is associated with a function having at least first and second parameters. If such an association is not present then the method 700 ends 780. If such an association is present then the first parameter is determined 750 based upon at least the first user input, and the second parameter is determined 760 based upon at least the second user input. Finally, the function is caused to be performed 770 according to the determined first and second parameters, and the method ends 780.

Without in any way limiting the scope, interpretation, or application of the claims appearing below, a technical effect of one or more of the example embodiments disclosed herein is that the use of more than one user input to determine the parameters of a function allows for a great deal of user-specified variation in the function's behaviour. The combination of touch user input and movement user input is surprisingly effective not least because these are input types that can easily be performed simultaneously by the user.

Example embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described elements may be optional or may be combined.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving a first user input indicative of a movement of a device;
receiving a second user input indicative of a touch gesture entered on the device;
determining that a combination of the first and second user inputs is associated with a function having at least first and second parameters;
determining the first parameter based upon at least the first user input;
determining the second parameter based upon at least the second user input; and
causing the function to be performed according to the determined first and second parameters.

2. The method of claim 1, wherein determining that the first and second user inputs are associated with the function comprises:
determining that the movement of the device and the entry of the touch gesture occur substantially simultaneously.

3. The method of claim 1, wherein the determining the first parameter is not based upon the second user input.

4. The method of claim 3, wherein the determination of the second parameter is not based upon the first user input.

5. The method of claim 1, wherein the first parameter is determined based at least upon at least one of a direction, acceleration, speed, and duration of the movement indicated by the first user input.

6. The method of claim 1, wherein the second parameter is determined based at least upon at least one of a location, shape, direction, acceleration, speed, duration and motion of the gesture.

7. The method of claim 1, wherein the function comprises playing a sound.

8. The method of claim 7, wherein at least one of the first and second parameters is an audio characteristic of the sound.

9. Apparatus comprising:
a processor; and
memory including computer program code,
the memory and the computer program code configured to, working with the processor, cause the apparatus to perform at least the following:
receive a first user input indicative of a movement of a device;
receive a second user input indicative of a touch gesture entered on the device;
determine that a combination of the first and second user inputs is associated with a function having at least first and second parameters;
determine the first parameter based upon at least the first user input;
determine the second parameter based upon at least the second user input; and
cause the function to be performed according to the determined first and second parameters.

10. The apparatus of claim 9, wherein determining that the first and second user inputs are associated with the function comprises:
determining that the movement of the device and the entry of the touch gesture occur substantially simultaneously.

11. The apparatus of claim 9, wherein the determining the first parameter is not based upon the second user input.

12. The apparatus of claim 9, wherein the determination of the second parameter is not based upon the first user input.

13. The apparatus of claim 9, wherein the first parameter is determined based at least upon at least one of a direction, acceleration, speed, and duration of the movement indicated by the first user input.

14. The apparatus of claim 9, wherein the second parameter is determined based at least upon at least one of a location, shape, direction, acceleration, speed, duration and motion of the gesture.

15. The apparatus of claim 9, wherein the function comprises playing a sound.

16. The apparatus of claim 9, wherein at least one of the first and second parameters is an audio characteristic of the sound.

17. The apparatus of claim 9, being a mobile telephone.

18. The apparatus of claim 9, being a tablet computing device.

19. The apparatus of claim 9, further comprising:
a movement sensor; and
a touch sensor,
and wherein:
the first user input is received from the movement sensor; and
the second user is received from a touch sensor.

20. A computer program product comprising a computer-readable medium bearing computer program code embodied therein for use with a computer, the computer program code comprising:
code for receiving a first user input indicative of a movement of a device;
code for receiving a second user input indicative of a touch gesture entered on the device;
code for determining that a combination of the first and second user inputs is associated with a function having at least first and second parameters;
code for determining the first parameter based upon at least the first user input;
code for determining the second parameter based upon at least the second user input; and
code for causing the function to be performed according to the determined first and second parameters.
